(19) United States
(12) Patent Application Publication
(10) Pub. No.: US 2024/0035335 A1
(43) Pub. Date: Feb. 1, 2024

(54) WIDTH-ADJUSTABLE INSTANT CURTAIN

(71) Applicant: NINGBO LIYANG NEW MATERIAL COMPANY LIMITED, Ningbo (CN)

(72) Inventors: Baoguo TAN, Ningbo (CN); Jianhong WEI, Ningbo (CN); Linrong HUANG, Ningbo (CN)

(21) Appl. No.: 18/223,867

(22) Filed: Jul. 19, 2023

(30) Foreign Application Priority Data
Jul. 31, 2022 (CN) 202222030111.X

(51) Int. Cl. E06B 9/388; E06B 9/262; E06B 9/32

(52) U.S. Cl. CPC E06B 9/388; E06B 9/262; E06B 9/32

(57) ABSTRACT

The present invention provides a width-adjustable instant curtain which comprises a length-adjustable upper mounting portion, a cuttable curtain body, a length-adjustable lower counterweight portion capable of smoothing up a lower end of the curtain body, and a pull rope; the curtain body is connected between the upper mounting portion and the lower counterweight portion, and the pull rope runs through and connects the upper mounting portion, the curtain body and the lower counterweight portion, through the cooperation of the length-adjustable upper mounting portion, the cuttable curtain body, the length-adjustable lower counterweight portion, the finished curtain can be freely re-sized to adapt to different mounting sizes of the window frames. Furthermore, the lower counterweight portion of the curtain can smooth up the lower end of the curtain body to enable the curtain body to unfold smoothly, ensuring the aesthetics of the curtain.

This application is based upon and claims priority to Chinese Patent Application No. 202222030111.X, filed on Jul. 3 2022, the entire contents of which are incorporated herein by reference.

### TECHNICAL FIELD

The present invention relates to the field of curtain technologies, and in particular to a width-adjustable instant curtain.

### BACKGROUND

Generally, curtains have fixed sizes when they are sold. People purchase the curtains according to measured sizes because it is inconvenient for people to cut them to the measured sizes. A curtain usually has an upper beam and a lower beam, and their lengths are the same as the width of the curtain body and thus can help the curtains to open and close smoothly. However, these beams cannot be cut with an ordinary tool and their length sizes cannot be changed freely. Those instant curtains which can be re-sized freely have a major structure of a curtain body, and the curtain body is adhered to a window frame by a top adhesive layer, resulting in easy mounting and free re-sizing. However, the curtain of such structure has poor aesthetics and the lower structure of the curtain body easily droops or sags un-smoothly. It is urgent to find a way to realize free resizing of a curtain and ensure smooth unfolding of a lower part of the curtain.

### SUMMARY

Considering the current situations of the prior arts, the present invention aims to provide a width-adjustable instant curtain, which can be freely adjusted in width to adapt to the mountings of various sizes and also assist a lower part of a curtain body in unfolding smoothly.

In order to address the above technical problems, the present invention adopts the following technical solution: provided is a width-adjustable instant curtain, comprising a length-adjustable upper mounting portion, a cuttable curtain body, a length-adjustable lower counterweight portion capable of smoothing up a lower end of the curtain body, and a pull rope. The curtain body is connected between the upper mounting portion and the lower counterweight portion, and the pull rope runs through and connects the upper mounting portion, the curtain body and the lower counterweight portion.

Furthermore, the counterweight portion comprises a counterweight beam and a smoothing structure in cooperation with the counterweight beam. The counterweight beam is connected with the lower end of the curtain body and a length of the counterweight beam is less than a width of the curtain body.

Furthermore, the smoothing structure is a cuttable hard transverse strip. The hard transverse strip is glued to the lower end of the curtain body and connected with the counterweight beam by insertion. A length of the hard transverse strip is same as the width of the curtain body to smooth up the lower end of the curtain body.

Furthermore, the smoothing structure comprises two telescoping secondary rods which are symmetrically and slidably connected to both ends of the counterweight beam and also connected to the lower end of the curtain body. The secondary rods may slide out of the counterweight beam to extend the length of the counterweight beam to be same as the width of the curtain body so as to assist in smoothing up the lower end of the curtain body.

Furthermore, an end cover is inserted at an end of the secondary rod away from the counterweight beam and provided with a hook portion for winding the pull rope.

Furthermore, a rope insertion hole for the pull rope to run through is provided at a midpoint position of the counterweight beam and a rope buckle for elastically clamping the pull rope is further disposed at the midpoint position of the counterweight beam.

Furthermore, an end of the pull rope running through the rope insertion hole and the rope buckle is connected with a rope pendant.

Furthermore, the upper mounting portion is an adhesive layer adhered to a top end of the curtain body, and a length of the adhesive layer and the width of the curtain body are same.

Compared with the prior arts, the present invention has the following advantages: through the cooperation of the length-adjustable upper mounting portion, the cuttable curtain body, the length-adjustable lower counterweight portion capable of smoothing up the lower end of the curtain body, the finished curtain can be freely re-sized to adapt to different mounting sizes of the window frames. Furthermore, the lower counterweight portion of the curtain can smooth up the lower end of the curtain body to enable the curtain body to unfold smoothly, ensuring the aesthetics of the curtain.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a front view of an embodiment of the present invention.

FIG. 2 is a structural schematic diagram illustrating an embodiment of the present invention.

FIG. 3 is a front view of another embodiment of the present invention.

FIG. 4 is a structural schematic diagram of another embodiment of the present invention.

FIG. 5 is a structural schematic diagram of a structure of an embodiment without a curtain body according to the present invention.

The numerals of the drawings are described below: 1 upper mounting portion, 2 curtain body, 3 pull rope, 4 counterweight beam, 4.1 rope insertion hole, 5 hard transverse strip, 6 secondary rod, 7 end cover, 7.1 hook portion, 8 rope buckle, and 9 rope pendant.

### DETAILED DESCRIPTIONS OF EMBODIMENTS

The present invention will be further described below in combination with the specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

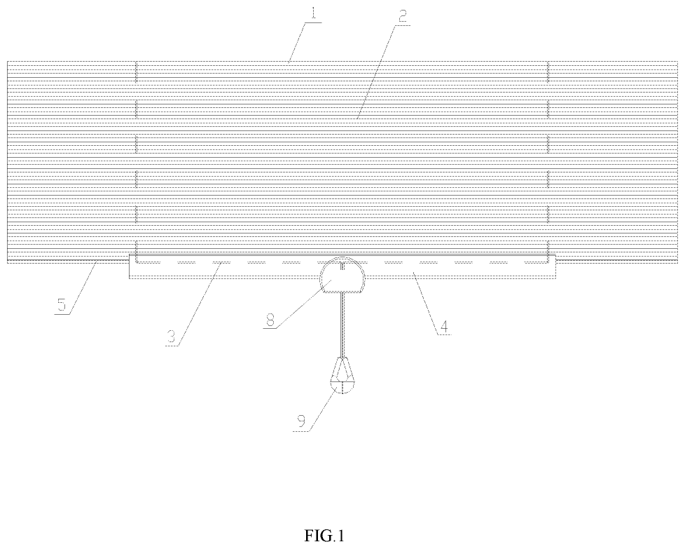

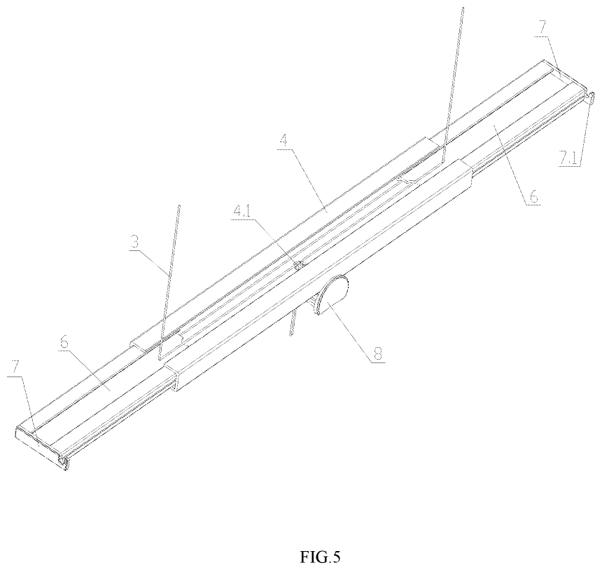

As shown in FIGS. 1 to 5, the present invention provides a width-adjustable instant curtain, comprising a length-adjustable upper mounting portion 1, a cuttable curtain body 2, a length-adjustable lower counterweight portion capable of smoothing up a lower end of the curtain body, and a pull rope 3. The curtain body 2 is connected between the upper mounting portion 1 and the lower counterweight portion, and the pull rope 3 runs through and connects the upper mounting portion 1, the curtain body 2 and the lower counterweight portion. The lower end of the curtain body 2 may slide up and down along the pull rope 3 together with the lower counterweight portion to achieve the opening and closing of the curtain body 2. It is noted that the length adjustment can be achieved by cropping, cutting and telescoping and the like to change the length or width.

Through cooperation of the length-adjustable upper mounting portion 1, the cuttable curtain body 2, the length-adjustable lower counterweight portion capable of smoothing up the lower end of the curtain body, the finished curtain can be freely re-sized to adapt to different mounting sizes of the window frames. Furthermore, the lower counterweight portion of the curtain can smooth up the lower end of the curtain body 2 and unfold the curtain body 2 smoothly, ensuring the aesthetics of the curtain.

The lower counterweight portion comprises a counterweight beam 4 and a smoothing structure in cooperation with the counterweight beam 4. The counterweight beam 4 is connected with the lower end of the curtain body 2 and a length of the counterweight beam 4 is less than a width of the curtain body 2. In order to use the weight of the counterweight beam 4 to pull down the curtain body 2, the counterweight beam 4 is usually made of aluminum profile material or plastic profile material which cannot be easily cut by ordinary consumers themselves. In order to facilitate size adjustment, a structure with a length shorter than the curtain body 2 is adopted, which can achieve the effect of both length adjustment and vertical spreading. At this time, because both ends of the curtain body 2 extending out of both ends of the counterweight beam 4 easily droop, the smoothing structure in cooperation with the counterweight beam 4 can be used to smooth up the lower end of the curtain body 2, achieving aesthetic effect.

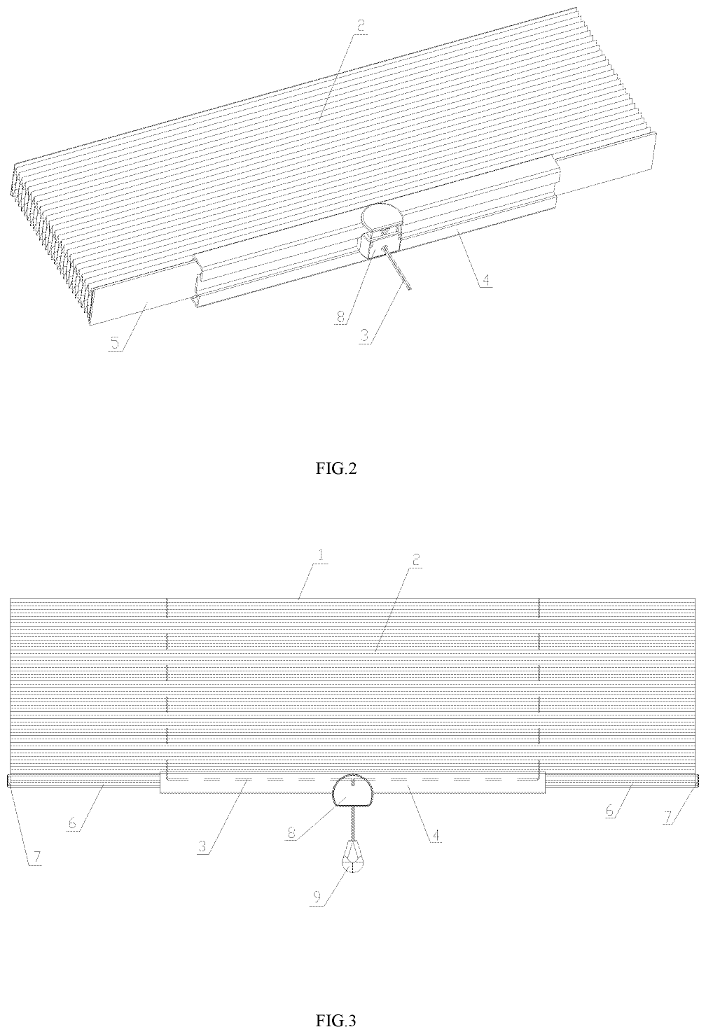

As a preferred embodiment, as shown in FIGS. 1 to 2, the smoothing structure is a cuttable hard transverse strip 5 such as plastic thin sheet, wooden thin sheet, and hard paper board, which can be easily cut and resized by the ordinary consumers. The hard transverse strip 5 is glued to the lower end of the curtain body 2 and connected with the counterweight beam 4 by insertion. A length of the hard transverse strip 5 is same as the width of the curtain body 2 to smooth up the lower end of the curtain body 2. In practical use, the consumers may cut the curtain body 2 and the hard transverse strip 5 based on the size of the window frame while the length of the hard transverse strip 5 is always same as the width of the curtain body 2 to smooth up the lower end of the curtain body 2.

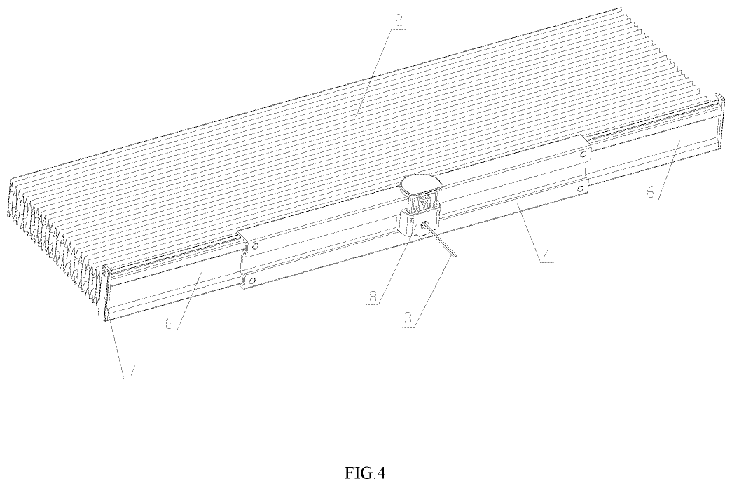

As another preferred embodiment, as shown in FIGS. 3 to 5, the smoothing structure comprises two telescoping secondary rods 6 which are symmetrically and slidable connected to both ends of the counterweight beam 4 and also connected to the lower end of the curtain body 2. The secondary rods 6 may slide out of the counterweight beam 4 to extend the length of the counterweight beam 4 to be same as the width of the curtain body 2 so as to assist in smoothing up the lower end of the curtain body 2. Connecting the secondary rods 6 symmetrically and slidably at both ends of the counterweight beam 4 may refer to connecting the secondary rods 6 slidably in the counterweight beam 4 or connecting the secondary rods 6 slidably outside the counterweight beam 4 as long as length adjustment can be achieved by sliding and telescoping. In practical use, the consumers can cut the curtain body 2 based on the size of the window frame and then smooth up both ends of the curtain body 2 extending out of the counterweight beam 4 by telescoping the secondary rods 6.

An end cover 7 is inserted at an end of the secondary rod 6 away from the counterweight beam 4 and provided with a hook portion 7.1 for winding the pull rope 3. The hook portion 7.1 is disposed to wind and receive the pull rope 3, which not only achieves the aesthetic effect but also prevents children from pulling the pull rope 3, thus avoiding safety accidents.

A rope insertion hole 4.1 for the pull rope 3 to run through is provided at a midpoint position of the counterweight beam 4 and a rope buckle 8 for elastically clamping the pull rope 3 is further disposed at the midpoint position of the counterweight beam 4. The rope buckle 8 has an elastic dislocation structure for clamping the pull rope 3 such that the lower end of the curtain body 2 can stop at any position, bringing more flexibility and conveniences. The rope buckle 8 can clamp the pull rope 3 without any external force so as to achieve limitation effect. By pushing the counterweight beam 4 or pressing the rope buckle 8 to unlock, the curtain body 2 can be driven to slide up and down along the pull rope 3, thereby achieving opening and closing. It is noted that, since the clamping force of the rope buckle 8 for the pull rope 3 is not very large, the limitation of the rope buckle 8 for the pull rope 3 can be removed by pushing or pulling the counterweight beam 4 to achieve free slide of the curtain body 2, whereas the counterweight beam 4 can be stopped at any instantaneous position without any loosening once the counterweight beam 4 stops to enable the rope buckle 8 to clamp the pull rope 3. Therefore, the use is very convenient.

An end of the pull rope running through the rope insertion hole 4.1 and the rope buckle 8 is connected with a rope pendant 9, thus helping to pull the pull rope 3.

The upper mounting portion 1 is an adhesive layer adhered to a top end of the curtain body 2, and a length of the adhesive layer and the width of the curtain body 2 are same. The adhesive layer can be easily cut by ordinary tools. The curtain body 2 preferably is a shutter curtain or honeycomb curtain which can be easily cut. In the above structure, the curtain body 2 and the adhesive layer can be freely cut to adapt to the window frames of different sizes. In use, it is only required to tear off a protective film of the adhesive layer, attach the adhesive layer to a mounting position and then smooth it up.

In addition, it is noted that in the present invention, one or two or more pull ropes can be used. If one pull rope 3 is used, both ends of the pull rope 3 run through the upper mounting portion 1 and the curtain body 2 sequentially and symmetrically and come out of the rope insertion hole 4.1 and the rope buckle 8 together. If two pull ropes 3 are used, the two pull ropes 3 symmetrically run through the upper mounting portion 1 and the curtain body 2, the upper ends of the pull ropes 3 are fixedly connected with the upper mounting portion 1, and the lower ends of the pull ropes 3 run through the rope insertion hole 4.1 and the rope buckle 8 together. If a plurality of pull ropes 3 is used, it does not pay in both cost and structure, and thus no redundant descriptions are made herein. It is noted that the advantage of using one rope buckle 8 to clamp the pull rope 3 is that when the counterweight beam 4 is moved up and down, no left and right tilting and blocking will occur, resulting in smoother operation.

1. A width-adjustable instant curtain, wherein it comprises a length-adjustable upper mounting portion, a cuttable curtain body, a length-adjustable lower counterweight portion capable of smoothing up a lower end of the curtain body, and a pull rope; the curtain body is connected between the upper mounting portion and the lower counterweight portion, and the pull rope runs through and connects the upper mounting portion, the curtain body and the lower counterweight portion.

2. The width-adjustable instant curtain of claim 1, wherein the counterweight portion comprises a counterweight beam and a smoothing structure in cooperation with the counterweight beam; the counterweight beam is connected with the lower end of the curtain body and a length of the counterweight beam is less than a width of the curtain body.

3. The width-adjustable instant curtain of claim 2, wherein the smoothing structure is a cuttable hard transverse strip, and the hard transverse strip is glued to the lower end of the curtain body and connected with the counterweight beam by insertion; a length of the hard transverse strip is the same as the width of the curtain body to smooth up the lower end of the curtain body.

4. The width-adjustable instant curtain of claim 2, wherein the smoothing structure comprises two telescoping secondary rods which are symmetrically and slidably connected to both ends of the counterweight beam and also connected to the lower end of the curtain body; the secondary rods may slide out of the counterweight beam to extend the length of the counterweight beam to be same as the width of the curtain body so as to assist in smoothing up the lower end of the curtain body.

5. The width-adjustable instant curtain of claim 4, wherein an end cover is inserted at an end of the secondary rod away from the counterweight beam and provided with a hook portion for winding the pull rope.

6. The width-adjustable instant curtain of claim 2, wherein a rope insertion hole for the pull rope to run through is provided at a midpoint position of the counterweight beam and a rope buckle for elastically clamping the pull rope is further disposed at the midpoint position of the counterweight beam.

7. The width-adjustable instant curtain of claim 6, wherein an end of the pull rope running through the rope insertion hole and the rope buckle is connected with a rope pendant.

8. The width-adjustable instant curtain of claim 1, wherein the upper mounting portion is an adhesive layer adhered to a top end of the curtain body, and a length of the adhesive layer and the width of the curtain body are same.
